(19) United States
(12) Patent Application Publication
(10) Pub. No.: US 2018/0267590 A1
(43) Pub. Date: Sep. 20, 2018

(54) REPEATER DEVICE, REPEATER CHIP, CARD DEVICE, SIGNAL TRANSMISSION APPARATUS, METHOD FOR SETTING A REPEATER RELATED PARAMETER AND PROGRAM FOR SETTING A REPEATER RELATED PARAMETER

(71) Applicant: NEC Corporation, Tokyo (JP)

(72) Inventor: Teruyoshi HATANAKA, Tokyo (JP)

(73) Assignee: NEC Corporation, Tokyo (JP)

(21) Appl. No.: 15/883,225

(22) Filed: Jan. 30, 2018

(30) Foreign Application Priority Data
Mar. 15, 2017 (JP) 2017-050026

(51) Int. Cl. G06F 1/32; G06F 3/06

(52) U.S. Cl. CPC G06F 1/3221; G06F 3/0634; G06F 3/0689

(57) ABSTRACT

A repeater device, comprises: a repeater related parameter storage configured to store a plurality of repeater related parameters corresponding to a cable length of a cable transmitting a signal; a repeater related parameter decision part configured to decide the repeater related parameter from among the plurality of repeater related parameters with reference to the repeater related parameter storage according to the cable length of the cable to be used; and a repeater related parameter setting part configured to set the decided repeater related parameter.

### TECHNICAL FIELD

### Cross Reference to Related Applications

The present application claims the benefit of the priority under the Paris-Convention based on Japanese Patent Application No. 2017-050026 filed on Mar. 15, 2017, the entire disclosure thereof being incorporated herein by reference thereto.

The present disclosure relates to a repeater device, a repeater chip, a card device, a signal transmission apparatus, a method for setting a repeater related parameter and a program for setting a repeater related parameter.

### BACKGROUND

In an apparatus that transmits a signal by an inter-cabinet connection using a cable, for example in a disk array apparatus or a server system, a repeater is used to improve the quality of the signal to be transmitted.

An example of a Configuration of connection using a repeater chip is shown below:

Interface (I/F) chip—repeater chip—cable—interface chip.

In a cable transmission, the longer the cable is, the greater is the attenuation of the signal, resulting in lowering in the signal quality. In order to ensure the signal quality, optimization of the transmission parameter of the interface chip is attempted.

[Patent Document 1] JP Patent Kokai Publication No. 2008-041050 (see paragraph 0043)

### SUMMARY

The disclosure of the above Patent Document is incorporated herein by reference thereto. The analysis of the related technique described above is given below.

Due to increasing the speed of the transmission signal, there are some cases that signal quality cannot be secured merely by optimizing the transmission parameter of the interface chip. In such a case, the signal quality is secured by manners such as changing a layout design of a motherboard based on craftsmanship technology, changing into a PCB (Printed Circuit Board) material having better characteristics, or restricting the cable length to be used, etc. However, the above manners depend on a personal design technique. Therefore, there is a risk of causing an increase in cost and a reduction in opportunity of use due to the restriction of the installation location of the apparatus.

Patent Document 1 discloses an example in which a repeater receives a “power management parameter” from a management terminal and sets it. The power management parameter includes “access standby time”, “minimum drive number”, “restart interval” and “total I/O access amount”. Therefore, the parameter to be set is not a parameter related to the signal transmission.

It is one of purposes of the present disclosure, to provide a repeater technology that can contribute to easily improve a signal quality according to a cable length of a cable transmitting a signal. Other objects and advantages will become apparent to a person skilled in the art from the entire disclosure.

According to one aspect of the present disclosure, a repeater device is provided, which comprises:

a repeater related parameter storage configured to store a plurality of repeater related parameters corresponding to a cable length of a cable transmitting a signal;
a repeater related parameter decision part configured to decide the repeater related parameter from among the plurality of repeater related parameters with reference to the repeater related parameter storage according to the cable length of the cable to be used; and
a repeater related parameter setting part configured to set the decided repeater related parameter.

The above-mentioned apparatus can be constructed by using for example, at least one of semiconductor chip, firmware, switch and a computer readable recording medium storing a program etc. (for example, HDD (Hard Disk Drive), CD (Compact Disk)/DVD (Digital Versatile Disk), or non-transitory computer readable recording medium, such as a semiconductor storage device or the like), but it is not limited thereto.

According to one aspect of the present disclosure, a repeater device is provided, which comprises:

a repeater related parameter storage configured to store a plurality of repeater related parameters corresponding to a cable length of a cable transmitting a signal;
a repeater related parameter decision part configured to decide the repeater related parameter from among the plurality of repeater related parameters with reference to the repeater related parameter storage according to the cable length of the cable to be used; and
a repeater related parameter setting part configured to set the decided repeater related parameter.

According to one aspect of the present disclosure, a repeater chip is provided, which comprises:

a repeater related parameter decision part configured to decide the repeater related parameter from among a plurality of repeater related parameters according to a cable length of a cable to be used; and
a repeater related parameter setting part configured to set the decided repeater related parameter.

According to one aspect of the present disclosure, a card device is provided, which comprises:

an interface chip configured to set a transmission parameter according to a cable length of a cable to be used;
a cable length detection part configured to detect the cable length based on the transmission parameter of the interface chip;
a repeater related parameter decision part configured to decide the repeater related parameter from among a plurality of repeater related parameters according to the cable length, and
a repeater related parameter setting part configured to set the decided repeater related parameter.

According to one aspect of the present disclosure, a signal transmission apparatus, for example a disk array apparatus, a server and the like is provided, which includes the at least one card device.

According to one aspect of the present disclosure, a method for setting a repeater related parameter is provided, which comprises:

storing a plurality of repeater related parameters corresponding to a cable length of a cable transmitting a signal,
deciding the repeater related parameter from among the plurality of repeater related parameters according to the cable length of the cable to be used, and
setting the decided repeater related parameter.

According to one aspect of the present disclosure, a program for setting a repeater related parameter is provided, which is configured to be executed in a computer:

processing of storing a plurality of repeater related parameters corresponding to a cable length of a cable transmitting a signal,
processing of deciding the repeater related parameter from among the plurality of repeater related parameters according to the cable length of the cable to be used, and
processing of setting the decided repeater related parameter.

Further, a computer readable recording medium storing the above program etc. (for example, HDD (Hard Disk Drive), CD (Compact Disk)/DVD (Digital Versatile Disk), a non-transitory computer readable recording medium such as semiconductor storage device or the like) is provided.

According to one or another aspects of the present disclosure, it is possible to provide a repeater technology that can contribute to easily improve a signal quality according to a cable length of a cable transmitting a signal.

### BRIEF DESCRIPTION OF THE DRAWINGS

FIG. 1 is a diagram showing an example of a signal transmission apparatus to which a repeater technique according to an exemplary embodiment can be applied;

FIG. 2 is a table for explaining differences between parameter setting methods according to the related techniques 1 to 3 and according to an exemplary embodiment;

FIG. 3 is a table for explaining differences between signal transmission qualities according to the related technology 3 and according to an exemplary embodiment;

FIG. 4 is a diagram for explaining an operation of a repeater device according to an exemplary embodiment;

FIG. 5 is a diagram for explaining a detailed example of the repeater device shown in FIG. 4;

FIG. 6 is a diagram for explaining an operation example of the repeater device shown in FIG. 5;

FIG. 7 is a table showing an example of repeater related parameters according to an exemplary embodiment; and

FIG. 8 is a diagram for explaining a basic concept of the repeater technology according to an exemplary embodiment.

It is noted that the connecting line(s) represents dual direction of signal transmission, and in general has input/output port (interface) at the connecting end thereof. Also an arrow does not restrict the direction in one way but should be interpreted to allow the other direction, too, upon needs.

### PREFERRED MODES

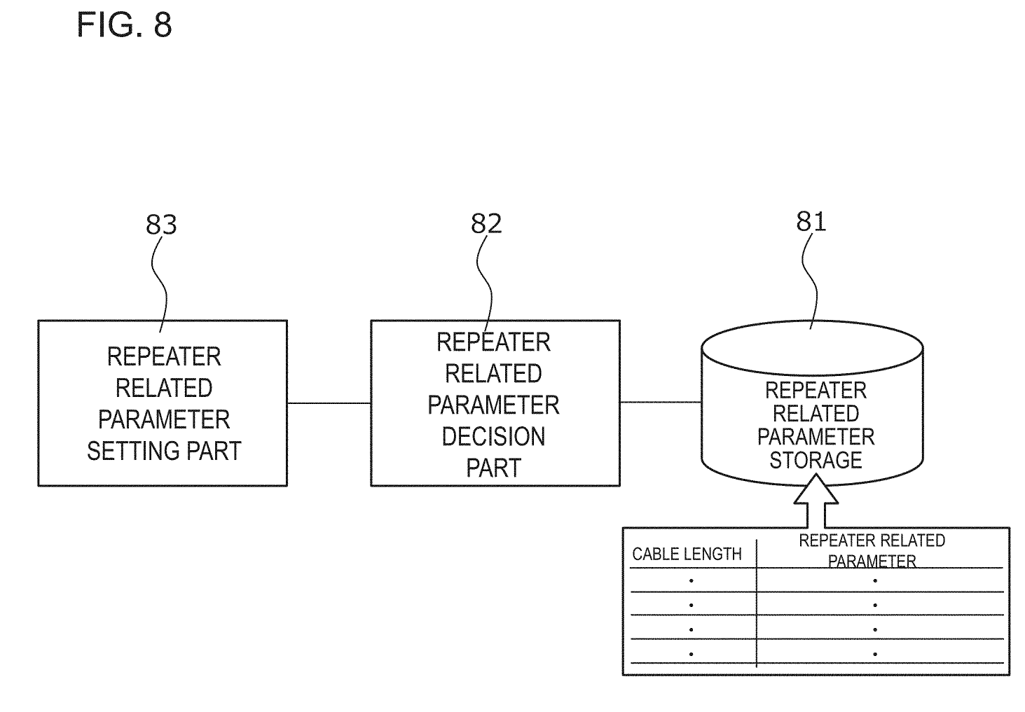

A basic concept of a repeater technique according to one exemplary embodiment will be described. Referring to FIG. 8, a repeater device includes a repeater related parameter storage 81, a repeater related parameter decision part 82, and a repeater related parameter setting part 83.

The repeater related parameter storage 81 stores a plurality of repeater related parameters corresponding to a cable length of a cable transmitting a signal.

The repeater related parameter decision part 82 decides a repeater related parameter according to a cable length of a cable to be used from among the plurality of repeater related parameters with reference to the repeater related parameter storage 81.

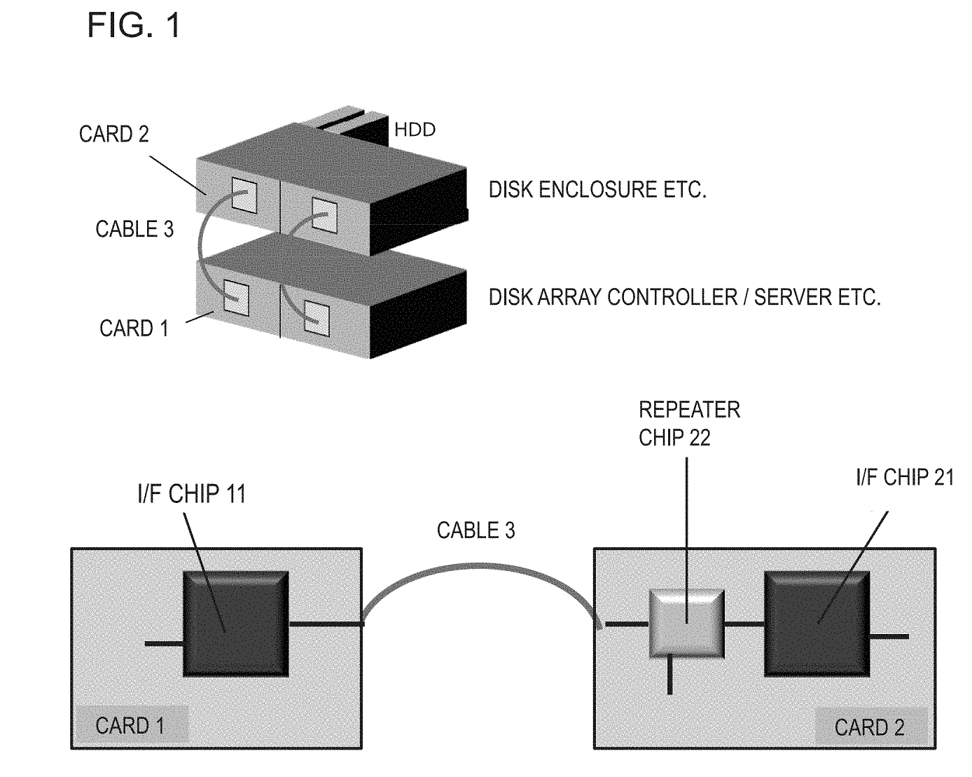

The repeater related parameter setting part 83 sets the decided repeater related parameter in the repeater device, for example, such as a repeater chip 22 shown in FIG. 1.

According to the repeater technique of the one exemplary embodiment, it is possible to set automatically the parameter of the repeater device according to the cable length of the cable connecting between the cards or the like. This makes it possible to easily improve the signal quality to be transmitted.

The repeater technology according to the one exemplary embodiment can be widely applied to a storage device such as a disk array device that implements the signal transmission using a cable, especially the high-speed signal transmission, or a server having the storage device or connected thereto. The repeater technology according to the one exemplary embodiment can be suitably applied to the high-speed signal transmission such as SAS (Serial Attached SCSI (Small Computer System Interface)) signal transmission or PCIe (PCI (Peripheral Component Interconnect) Express), but its application range is not limited to this.

Next, an example of a signal transmission apparatus to which the repeater technique according to the one exemplary embodiment can be applied will be described. Referring to the upper part of FIG. 1, this signal transmission apparatus connects a card (card device) 1 on a disk array controller (for example, server) side and a card (card device) 2 on a disk enclosure (hard disk HDD) side so that the signals are transmitted via a cable 3.

Referring to the lower part of FIG. 1, the card 1 comprises an interface (I/F) chip 11, and the card 2 comprises an interface chip 21 and a repeater chip 22. The interface (I/F) chip 11 and the interface chip 21 are connected via the cable 3 and the repeater chip 22 so that the signals are transmitted.

As the repeater device or the repeater chip which is disposed between the interface chips 11 and 21, and configured to compensate an attenuation of signals, there are LSI products such as repeater/re-driver/re-timer, but the present disclosure is not limited thereto. In the case of SAS communication, an LSI chip such as a repeater chip etc. can be arranged on the controller board at the design stage in the middle of the path between a SAS controller or SAS switch LSI chip—SAS cable—SAS switch LSI chip.

In order to compensate the attenuation of the SAS signal, the repeater device or the repeater chip applies equalization or emphasis to the input/output SAS waveform. User can set the equalization or emphasis in one combination as a variable parameter. In the case of this embodiment, these variable parameters can be set according to at least the cable length, furthermore the board design and the like.

Here, related technologies 1 to 3 for securing a signal quality, which are applied to the above-described signal transmission apparatus, will be introduced and compared with the one exemplary embodiment.

(Related technology 1)
Configuration of connection: I/F chip—Cable—I/F chip
   The transmission parameter of the I/F chip takes a fixed value.
   (Related technology 2)
Configuration of connection: I/F chip—Cable—I/F chip
   The transmission parameter of the I/F chip takes an optimum value by negotiation.
   (Related technology 3)
Configuration of connection: I/F chip—Cable—Repeater chip—I/F chip
   The transmission parameter of the I/F chip takes an optimum value by negotiation;
   The transmission parameter of the repeater chip takes a fixed value.

### One Exemplary Embodiment

Configuration of connection: I/F chip—Cable—Repeater chip—I/F chip
   The transmission parameter of the I/F chip takes an optimum value by negotiation;
   The transmission parameter of the repeater chip takes an optimum value by negotiation.

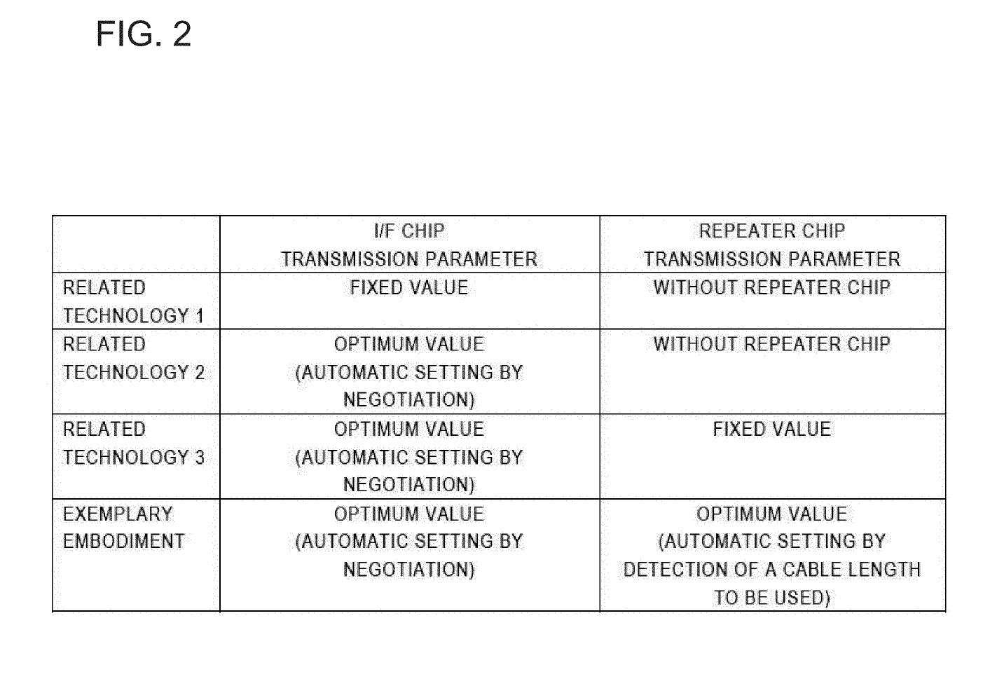

FIG. 2 is a table for explaining the differences between the parameter setting methods according to related techniques 1 to 3 described above and according to the one exemplary embodiment.

Referring to FIG. 2, it can be perceived that only in the one exemplary embodiment the repeater related parameter (repeater chip transmission parameter) can be used as a variable and further set optimally according to the cable length.

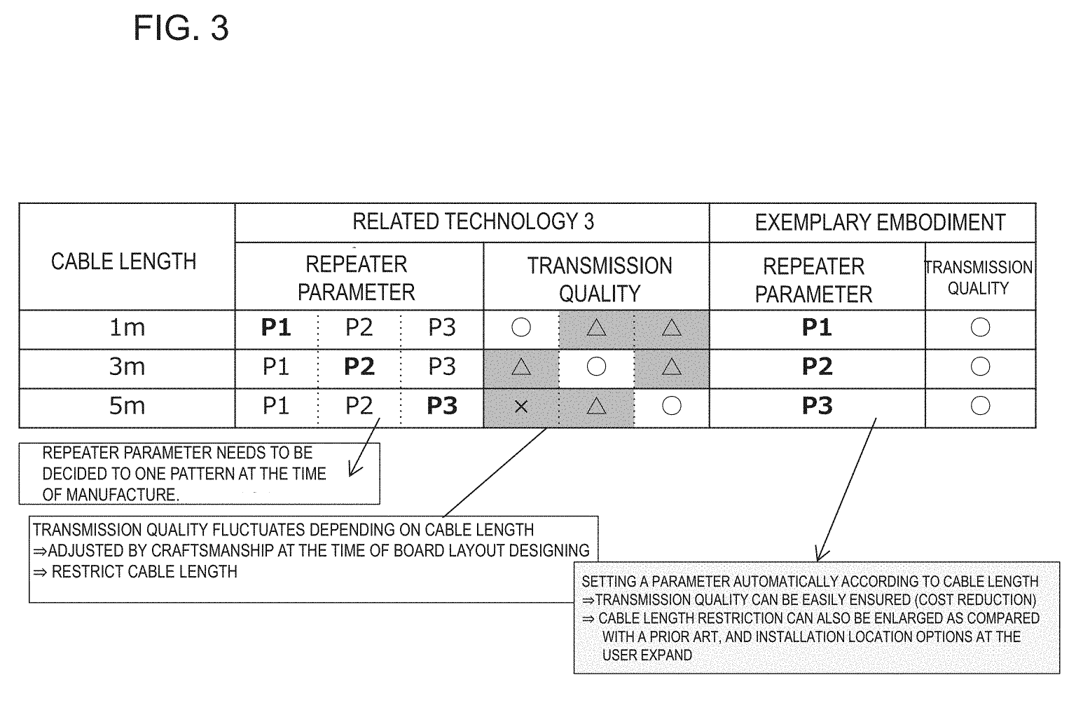

FIG. 3 is a table for explaining the differences between the signal transmission qualities according to related technology 3 that has the repeater chip among related technologies 1 to 3, and according to the one exemplary embodiment.

Referring to FIG. 3, in related technology 3, the repeater related parameter is set to one pattern at the time of manufacturing the repeater chip, and does not correspond to the cable length used actually. Therefore, the signal transmission quality may be degraded, depending on the cable length used.

By contrast, according to the one exemplary embodiment, the repeater related parameter (repeater parameter) can be set optimally according to the cable length even after the repeater chip is produced. Therefore, even if the cable length is changed, the signal transmission quality can be secured by changing the repeater related parameter adaptively.

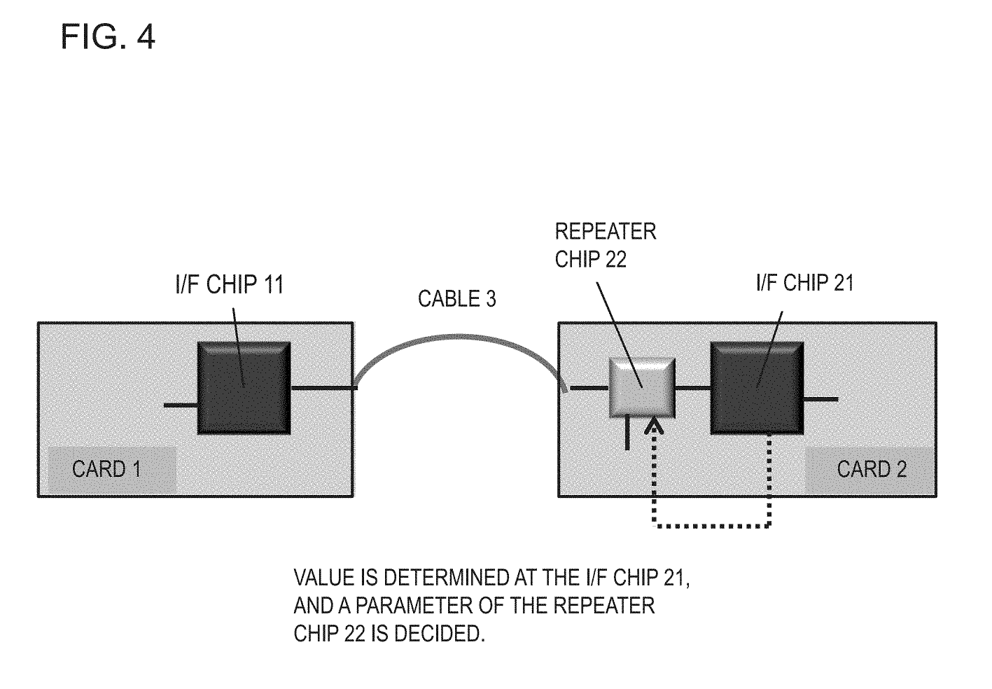

FIG. 4 is a diagram for explaining an operation of the repeater device according to the one exemplary embodiment described above. Referring to FIG. 4, in the configuration in which the cable 3 and the repeater chip 22 are connected between the interface chips 11 and 21, the cable length of the cable 3 is detected and an optimum transmission parameter is set for the repeater based on the cable length.

The interface chip 21 has a transmission parameter setting part (not shown) configured to set a transmission parameter according to the situation of signal transmission. The repeater chip 22 can read out the set transmission parameter from the interface chip 21 and determine the cable length from the read transmission parameter by referring to a prepared table. The repeater chip 22 can decide the repeater related parameter to be set from the cable length by referring to the repeater related parameter storage 81 in FIG. 8, and apply the decided repeater related parameter to itself.

For detecting the length of the cable to be connected a method disclosed in Japanese Patent Application No. 2008-242863 may be used, the disclosure thereof being incorporated herein by reference thereto. The disclosure thereof being incorporated herein by reference thereto. In some cases, the interface chip 21 also may hold or read out the repeater related parameter corresponding to the cable length and transfer the parameter to the repeater chip 22. In FIG. 4, the repeater device includes the card 2 on which the repeater chip 22 and the interface chip 21 are mounted, but the present disclosure is not limited thereto. The repeater device may be composed of two or more cards and may be configured via a wireless connection.

### EXAMPLES

Examples of the present disclosure will be described with reference to the drawings.

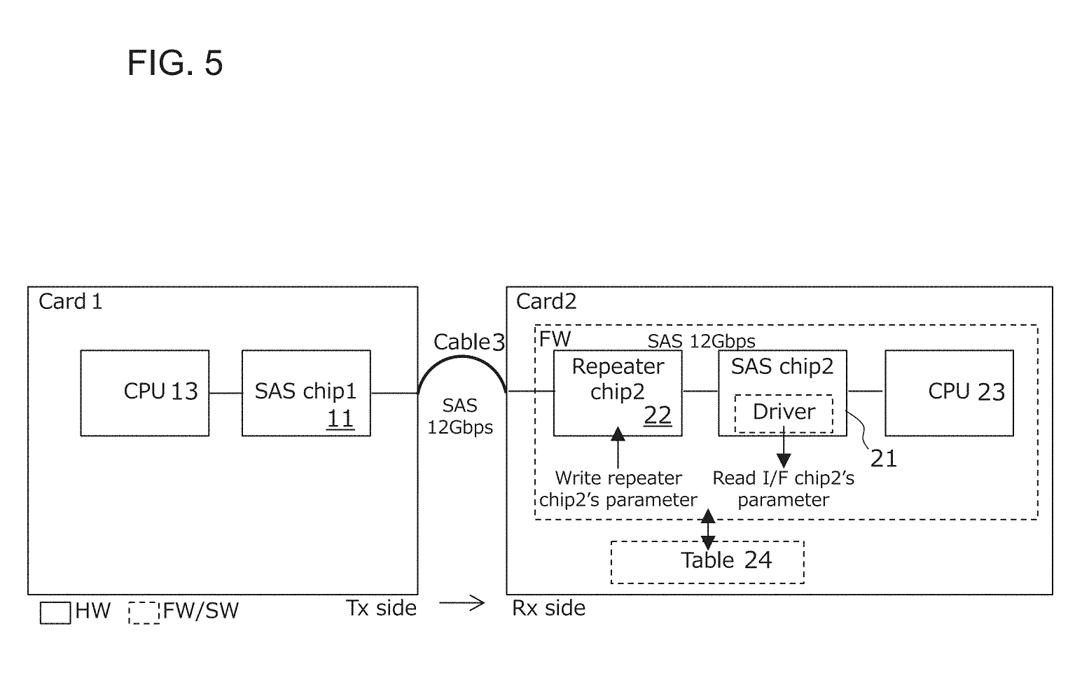

FIG. 5 shows an example in which the repeater technology according to the one exemplary embodiment is provided to the disk array device. Referring to FIG. 5, the card 1 is arranged on the transmitting side, and is mounted on the controller side (see FIG. 1), for example. The card 2 is arranged on the receiving side, and is mounted on the disk array device side (see FIG. 1). A cable 3 is connected between the cards 1 and 2. In this example, SAS 12 Gbps standard is used for the cable transmission, but the present disclosure is not limited thereto. This one exemplary embodiment can be similarly applied to other interface transmission standards such as PCIe.

Each of the elements mounted on the cards 1 and 2 can be constituted by HW (hardware), FW (firmware), and/or SW (software), or further a combination thereof.

The card 1 has a SAS chip (1) 11 as an interface chip and a CPU (Central Processing Unit) (control part) 13 as a control part of the card 1. CPU generally includes at least one processor, memory and input/output port (or interface).

The card 2 has a SAS chip (2) 21 as an interface chip, a repeater chip 22, and a CPU (control part) 23 as a control part of the card 2. Further, the repeater chip 22 etc. can refer to a table 24 storing the cable length and the repeater related parameter in association with each other. The table 24 is preferably arranged inside the card 2, but it may be located elsewhere.

By referring to the table 24 using the cable length as a key, it is possible to optimally set an optimum repeater related parameter corresponding to the cable length. For example, a signal amplification factor or a parameter relating to a filter for a predetermined frequency component can be set optimally.

When a signal is transmitted from the CPU 13 of the card 1 to the CPU 23 of the card 2, the signal path is in order of the CPU 13, the SAS chip 11, the cable 3, the repeater chip 22, the SAS chip 21 and the CPU 23.

In FIG. 5, the repeater chip 22 is arranged on the receiving side, but it may be arranged on the transmitting side or on both sides. It is preferable that the repeater chip 22 obtain necessary parameters from the interface chip (SAS chip) 21 which is mounted on the card 2 on which the repeater chip 22 is mounted.

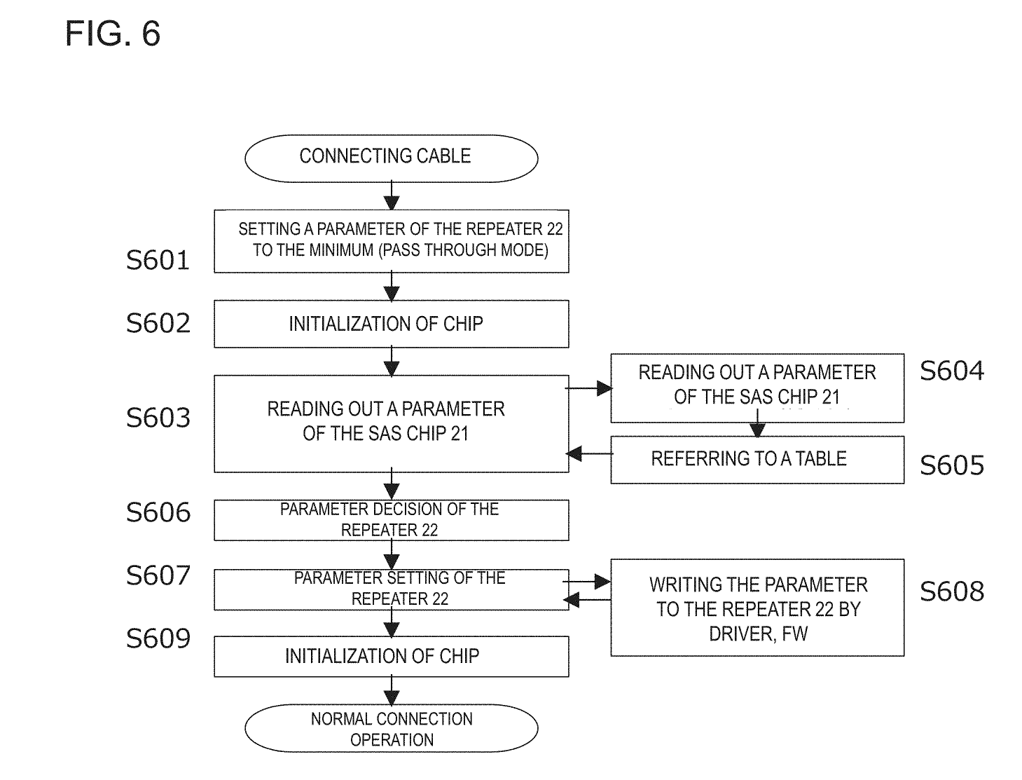

The operation of the apparatus shown in FIG. 5 will be described with reference to the flowchart of FIG. 6. Since the repeater related parameter is set according to the cable length used, the timing of the operation start is the timing at which the transmission is started via the cable.

Referring to FIGS. 5 and 6, first the cable 3 is connected between the cards 1 and 2. In S601, the repeater chip 22 initially sets the repeater related parameter to the minimum value (pass through mode). With this setting, the signal becomes to be not corrected, and the signal goes through the repeater chip 22.

In S 602, the repeater chip 22 is initialized in this state.

In S 603, the transmission between the SAS chips 11, 21 is linked up, and subsequently, the transmission parameter determination of the SAS chip 21 is executed.

In S 604, the repeater chip 22 reads out the transmission parameter set according to the cable length of the SAS chip 21, and detects the actual cable length of the cable 3 from the transmission parameter.

In S 605, the repeater chip 22 refers to the table 24 with the cable length as a key, and in S 606, decides the repeater related parameter corresponding to the cable length.

In S607 to S608, the repeater chip 22 sets the decided repeater related parameter to itself or the repeater related elements by using the driver and FW.

In S 609, the chip is initialized again, and the setting of the transmission parameter between the SAS chips 11 and 21 is completed.

In the flowchart described above, although the processing has been excused mainly by the repeater chip 22, the CPU 23 may mainly process the processing.

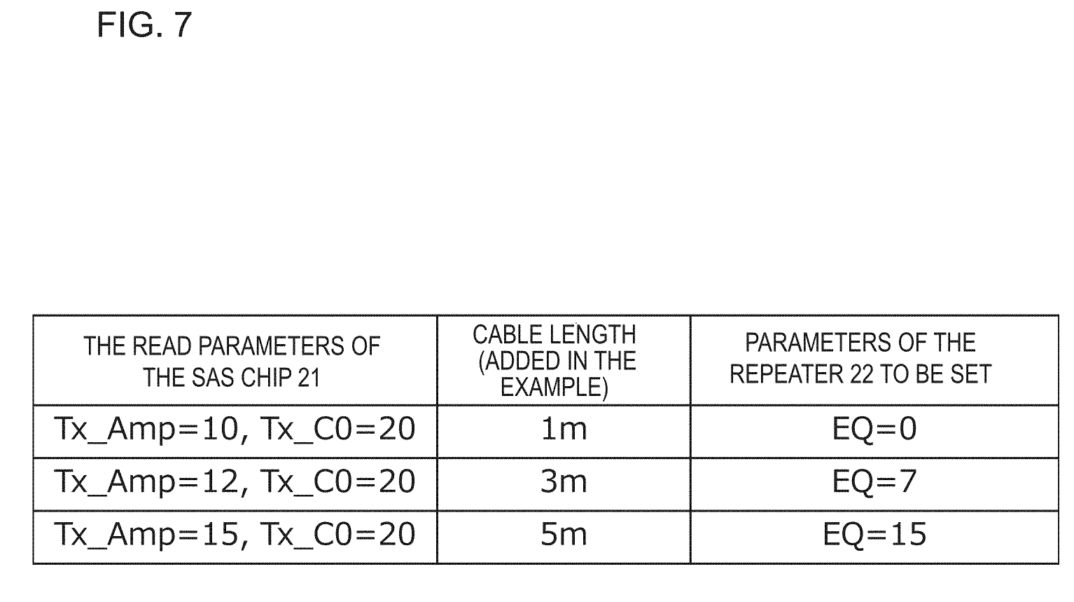

FIG. 7 is a diagram for explaining an example of the contents of the table 24 shown in FIG. 5. The link related parameter stored in the table 24 can be set based on data acquired in advance by using an evaluation machine.

Referring to the data structure of FIG. 7, the transmission parameter of the SAS chip 21 corresponding to the cable length of the cable 3, the cable length, and the repeater related parameter of the repeater chip 22 optimized corresponding to the cable length are associated and stored. Here, it is recognized that the value of Tx_Amp (amplification factor on the transmission side) among the transmission parameters of the SAS chip 21 fluctuates when the cable length changes. Therefore, by reading out Tx_Amp, the cable length of the connected cable 3 can be estimated. Then, it is possible to set the repeater related parameter optimized according to the actual cable length, for example an equalizer value.

According to the repeater technique related to the one exemplary embodiment, first, there is an effect of improving the signal quality of high-speed signal transmission via a cable. By a preliminary evaluation, it will be easy to secure an operational margin for the transmission standard by grasping the correlation between the three parameters, i.e. the interface chip parameter in the card to be used, the cable length and the repeater related parameter, and then creating the table.

Even in the case where it is impossible to avoid the operation near the standard even after manufacturing by designing, it is possible to provide the operational margin by using the repeater technique according to the one exemplary embodiment. As a result, an improvement of the signal quality can be realized. By the improvement of the signal quality, it is possible to expect degradation of failure rate.

As other effects, restrictions on the place where the apparatus is installed are relaxed, and the opportunity for introducing the apparatus is increased, because it is possible to respond flexibly to changes in the cable length. For example, there is an effect of alleviating the layout restriction in the time of cards design in interface chips, repeater chips, and connectors connected to cables, which generally have a high degree of difficulty and require many steps and cost owing to securing the signal quality. At the same time, it is possible to avoid the use of a substrate material with excessive good characteristics to match the long cable, and it is possible to expect a cost reduction effect.

Herein the disclosures of the above mentioned Patent literatures are incorporated in the present Description by reference thereto. It is possible to change/adjust the exemplary embodiments or examples within the entire disclosure (including claims and drawings) of the present disclosure, and further on the basis of basic technical thought thereof. Also, various combinations or selections of various disclosed elements (including each element of each claim, each element of each exemplary embodiment, and each element of each figure etc.) are possible within the ambit of claims of the present disclosure. It is self-evident that the present disclosure includes various variations and modifications which could be made by a person skilled in the art based on the entire disclosure including claims and the technical thought.

Although it is not particularly limited, modes and modifications etc. are possible as following Appendices.

### (Mode 1)

A repeater device in a connection using a cable in a signal transmission apparatus including a disk array device and a server system, wherein an optimum parameter is automatically set according to a cable length used.

### (Mode 2)

A repeater device in a configuration in which a repeater and a cable are connected between interface chips, configured so that an optimum transmission parameter for the repeater is set by detecting a cable length used for the connection.

### (Mode 3)

A repeater device, configured to read out a transmission parameter of an interface chip from the interface chip, determine a cable length from the transmission parameter by referring to a prepared table, further decide a repeater (related) parameter to be set from the cable length, and set the decided repeater (related) parameter.

### (Mode 4)

A program for setting a repeater related parameter, configured to execute in a computer:

processing of storing a plurality of repeater related parameters corresponding to a cable length of a cable transmitting a signal,

processing of deciding the repeater related parameter from among the plurality of repeater related parameters according to the cable length of the cable to be used, and

processing of setting the decided repeater related parameter.

### REFERENCE SIGNS LIST

1 card, card device
2 card, card device
3 cable
11 interface (I/F) chip
13 CPU
21 interface (I/F) chip
22 repeater chip
23 CPU
24 table
81 repeater related parameter storage
82 repeater related parameter decision part
83 repeater related parameter setting part

What is claimed is:

1. A repeater device, comprising:
a repeater related parameter storage configured to store a plurality of repeater related parameters corresponding to a cable length of a cable transmitting a signal;
a repeater related parameter decision part configured to decide the repeater related parameter from among the plurality of repeater related parameters with reference to the repeater related parameter storage according to the cable length of the cable to be used; and
a repeater related parameter setting part configured to set the decided repeater related parameter.

2. The repeater device according to claim 1, wherein
the repeater related parameter storage has a data structure that stores the cable length and the at least one repeater related parameter in association with each other.

3. The repeater device according to claim 1, further comprising:
an interface chip configured to set a transmission parameter according to the cable length, and
a cable length detection part configured to detect the cable length based on the transmission parameter of the interface chip.

4. The repeater device according to claim 2, further comprising:
an interface chip configured to set a transmission parameter according to the cable length, and
a cable length detection part configured to detect the cable length based on the transmission parameter of the interface chip.

5. The repeater device according to claim 1, wherein the repeater related parameter is set automatically to an optimum value according to the cable length of the cable used.

6. The repeater device according to claim 1, wherein an optimum transmission parameter adapted to the repeater device is set.

7. The repeater device according to claim 1, wherein the repeater device is configured to: read out a transmission parameter of an interface chip from the interface chip, determine a cable length from the transmission parameter by referring to a prepared table, and further decide a repeater (related) parameter to be set from the cable length, and set the decided repeater (related) parameter.

8. A repeater chip, comprising:
a repeater related parameter decision part configured to decide the repeater related parameter from among a plurality of repeater related parameters according to a cable length of a cable to be used; and
a repeater related parameter setting part configured to set the decided repeater related parameter.

9. A card device, for use in the repeater device according to claim 1, comprising:
an interface chip configured to set a transmission parameter according to a cable length of a cable to be used;
a cable length detection part configured to detect the cable length based on the transmission parameter of the interface chip;
a repeater related parameter decision part configured to decide the repeater related parameter from among a plurality of repeater related parameters according to the cable length, and
a repeater related parameter setting part configured to set the decided repeater related parameter.

10. A signal transmission apparatus, comprising:
at least one card device according to claim 9.

11. A method for setting a repeater related parameter, comprising:
storing a plurality of repeater related parameters corresponding to a cable length of a cable transmitting a signal;
deciding the repeater related parameter from among the plurality of repeater related parameters according to the cable length of the cable to be used; and
setting the decided repeater related parameter.
